(19) United States
(12) Patent Application Publication
(10) Pub. No.: US 2014/0372049 A1
(43) Pub. Date: Dec. 18, 2014

(54) Method and Computerproduct for Modeling the Sound Emission and Propagation of Systems Over a Wide Frequency Range

(71) Applicants: Hadrien Bériot, Le Vesinet (FR); Stijn Donders, Kessel-Lo (BE); Michel Tournour, Leuven (BE)

(72) Inventors: Hadrien Bériot, Le Vesinet (FR); Stijn Donders, Kessel-Lo (BE); Michel Tournour, Leuven (BE)

(21) Appl. No.: 14/307,292

(22) Filed: Jun. 17, 2014

(30) Foreign Application Priority Data
Jun. 17, 2013 (EP) 13172316.5

(51) Int. Cl. G01H 17/00

(52) U.S. Cl. CPC G01H 17/00
USPC 702/33

(57) ABSTRACT

Prediction of emission by a source of sound and a propagation of the sound within a surrounding medium, over a frequency range is provided. A system including the source and the surrounding medium is represented by elements e. For each element e and each frequency fᵢ, a parameter P_{e,i} is associated to the element. At frequency fᵢ, a parameter P_{e,max} is calculated over the frequency range. For each element e, elementary matrices K_{e,max} and M_{e,max} are determined using the parameter P_{e,max}. For each frequency fᵢ and for each element e, parameter P_{e,i} is used to determine a polynomial degree used to approximate the sound field, elementary matrices K_{e,i} and M_{e,i} are extracted out of the matrices K_{e,max} and M_{e,max} and are assembled into global matrices Kᵢ and Mᵢ. A global matrix system Zᵢ is established based on the global matrices Kᵢ and Mᵢ, and the global matrix system is solved.

This application claims the benefit of EP 13172316.5, filed on Jun. 17, 2013, which is hereby incorporated by reference in its entirety.

### TECHNICAL FIELD

The present embodiments relate to the field of predicting emission by a source of sound and a propagation of the sound within a surrounding medium.

### BACKGROUND

Health effects from noise are more and more recognized and are becoming a public health problem. Exposure to elevated sound levels is known to be very dangerous and may cause hearing impairment, hypertension and sleep disturbance, among others. The most significant risks are induced by vehicle and aircraft noise, extended exposure to loud music, and industrial noise.

These considerations have led noise reduction to become a mainstream issue for today's manufacturers. In the automotive industry, for example, sound emission is a full-fledged specification in car design. Customers would like to acquire quieter and quieter products for their own comfort. Authorized noise limits are tighter for cars, lorries and buses, without mentioning other sources.

At present, noise reduction is still limited by the lack of efficient predictive modeling tools to simulate the sound emission of mechanical systems. Computational acoustic simulations are to be improved to optimize product designs, while avoiding late and expensive physical testing. FIG. 1 presents an example of a computed sound pressure inside a car cavity at a given frequency, where the darker the areas, the higher the sound pressure inside the cavity.

By definition, a sound is a mechanical wave that is an oscillation of pressure transmitted through a solid, liquid, or gas, composed of frequencies within the range of hearing. Sound that is perceptible by humans has frequencies ranging from about 20 Hz to 20,000 Hz. In air, at standard temperature and pressure, the corresponding wavelengths of sound waves range from 17 m to 17 mm. A sound field in a given system is properly defined if sound pressure and acoustic velocity are known at all points of the system.

Acoustic wave propagation in a medium is a complex phenomenon. In order to describe acoustic wave propagation, physical models have been built by scientists, based on several approximations. The simulation of wave propagation is approximated by a set of partial differential equations. The analytical resolution of those equations has no simple solution, and the acoustic field solution is to be approximated using a computational method.

All major categories of numerical schemes have been applied to acoustics, including Finite Element Methods (FEM), Finite Difference Method (FDM), Discontinuous Galerkin Methods (DGM) and Boundary Element Methods (BEM). These methods may be categorized based on the use of time-domain or frequency-domain solvers. Frequency-domain solvers are better suited for permanent regimes (e.g., engine running), while time-domain solvers are used to study transient applications (e.g., door closing). Also, domain methods, where the fluid region of propagation is to be fully represented, and boundary methods that rely on a boundary integral representation of the initial problem may be distinguished between. Finite Elements and Discontinuous Galerkin Methods cope with unstructured meshes, to be defined below, and are better suited for complex real-life engineering problems. FEM is typically suited for frequency domain applications, and DGM is typically suited for transient applications. DGM may also be used in the frequency domain context.

The FEM remains the most popular method in the industry sector. The FEM is a numerical method for solving partial differential equations. Standard FEM procedure may be characterized by three main steps. First, a given mechanical system is divided into many small, non-overlapping and simple ‘elements’. The set of the simple elements or subdomains is called a ‘mesh’. The set of simple elements describes the geometry and, later, will include the properties and boundary conditions that define the problem of the simulation of wave emission and propagation. The process of creating a mesh is referred to as the meshing. Different shapes of elements may be used and handled by commercial FEM and DGM solutions (e.g., triangle, quadrangle, hexahedron, tetrahedron, prism, pyramid). Two meshes of the same car cavity are given as an illustration in FIG. 2 and FIG. 3. Second, piecewise polynomial approximations (e.g., based on shape functions) are constructed over each of these elements to approximate the field of interest (e.g., the pressure or the acoustic velocity). FIG. 4 discloses 16 examples of shape functions. The contributions of the shape functions to the field are the unknowns of the approximated problem. These discrete unknowns are linked on each subdomain by a set of elementary equations that involve time consuming quadrature rules. All these local contributions (e.g., the elementary matrices) are recombined into a global system of equations (e.g., the system matrix). All this process is referred to as the assembly of the system. In FIG. 4, some of these shape functions are rather simple, looking like flat squares of which one corner has been elevated. Other, more difficult to describe shape functions include bosses and recesses, representing local minima and maxima distributed over the element domain. A person of ordinary skill in the art is familiar with these shape functions. These shape functions build a hierarchical basis to be explained herein below. Third, the equation solving includes the solving of a set of linear equations involving the contribution of all the shape functions to the global problem. A sparse linear solver is used. The system matrix assembled and solved at each frequency is denoted Z(f). The dimension of this matrix is directly linked to the total number of shape functions in the system, which is given by the number of elements in the mesh times the number of polynomial shape functions inside each of the elements. In most cases, the matrix takes the following form:

Z(f)=K−(2πf)²M+C(f)

where K is the stiffness matrix, M is the mass matrix, and C(f) includes all other terms generally coming from boundary conditions. The mass and stiffness matrices may be frequency independent, and thus, the mass and stiffness matrices are to be computed only once and not at each frequency. This is what is typically done in standard FEM commercial solutions.

Each simple element, defined during the meshing, may be characterized by two main features: the dimension of the element h, which is a geometrical parameter, and the polynomial degree P of polynomials used to approximate the solutions (e.g., the order of interpolation of the given element).

The choice of these parameters h and P is an important aspect to be considered in acoustic simulation. Indeed, when solving in the frequency domain, where high-order (high P) method and multi-frequency solutions may be used, it is important to propose an efficient strategy to avoid assembling the algebraic system of equations repeatedly at each frequency. This step of assembly may be very computationally intensive in such cases.

The choice of h may be done by comparison with the frequency of sound that is studied. When solving in the frequency domain, each individual frequency of interest is to be solved independently. The list of frequencies is provided by the user in a list sorted in ascending order F=[f₁, f₂, . . . , f_{N}_{_{f}}]. The total number of frequencies N_{f} depends on the application, but the total number may be large, as the user may want to cover the full audio frequency range with a fine frequency increment. In standard low-order FEM, the meshing operation is designed based on the frequency f_{N}_{_{f}} in order to provide that an acoustic plane wave propagating at the frequency of interest has enough resolution. This “rule of thumb” is an approximation because the solution is not known a priori and will be more complex than just a plane wave. For linear finite elements, h may be approximated by the following equation:

$$h = \frac{{c}_{0}}{6 f}$$

with c₀ being the speed of sound in the propagation medium, f being the frequency to be studied, and h being the typical mesh dimension required for the meshing operation.

This formula indicates that low frequencies (large h) are less demanding than the high frequencies. This is illustrated in FIG. 2 and FIG. 3, where a coarse mesh is required for low frequencies (FIG. 2), and a refined mesh is required for the high frequencies (FIG. 3), respectively. The numerical cost associated with the coarse mesh is orders of magnitude smaller than the numerical cost associated with the thin mesh, as the number of elements and corresponding equations to resolve will be much smaller. For practical reasons, however, mostly because the meshing operation is cumbersome and cannot be automated, users often use a single mesh (e.g., the refined mesh) to compute the full frequency range F=[f₁, f₂, . . . , f_{N}_{_{f}}]. This implies a huge loss in terms of performance, as the low frequencies will typically be over-resolved.

The choice of P may be adapted locally based on some knowledge of the complexity of the field to be locally represented. For example, if the field is smooth and oscillating a lot, a high-order approximation (e.g., involving many shape functions) will be used locally. Finding the correct number of shape functions to apply on each individual element is important, as the computational cost of the method (e.g., the assembly and the solving procedures) is directly proportional to the number of shape involved.

There are two ways of fixing the order inside the elements, either with an a priori or an a posteriori error estimator. As indicated by the name, an estimator estimates the accuracy of a given solution, and helps “modeling engineers” to determine a set of P parameters. An a posteriori estimator refines P parameter after the equation solving, where an a priori estimator determines P parameter before the equation solving.

A Priori Error Estimator:

In applications of practical interest, the exact solution cannot be guessed before the computation. However, complex solutions are based on linear combinations of simple elementary solutions of the governing equation that are known prior to the computation (e.g., like plane wave solutions). A “rule of thumb” may be derived to fix the order just like for standard FEM to fix the mesh size. For example, at low frequency, the acoustic wavelength may be larger, and therefore, low polynomial orders (e.g., fewer shape functions) may be used. At high frequency, waves may oscillate more, and higher orders may be used.

A Posteriori Error Estimator:

In such a case, a first inexpensive solution is computed (e.g., at low-order). Based on an a posteriori analysis of the first rough solution (e.g., looking at the residual of the initial operator or at the behavior of the solution derivatives), the orders inside each element may be increased. Another solution is computed until the a posteriori error process judges the solution satisfactory everywhere. This is referred to as a P-adaptive method, where a sequence of converging solutions with incremental complexity is generated to solve a single frequency. P-adaptive methods are not widely used as such. P-adaptive methods may be seen as a particular case of the more general hP-adaptive methods, which will be introduced hereafter.

Several methods have been implemented in the prior art to model more accurately and more efficiently wave propagation systems. A first approach is the following one and is illustrated in FIG. 5 and FIG. 6. hP-adaptive FEM (and hP-adaptive DGM) is a general version of the Finite Element Method (and Discontinuous Galerkin Methods) that employs elements of variable dimensions h and polynomial degree P that are adjusted locally based on a posteriori error estimators. The origins of hP-FEM date back to the pioneering work of Ivo Babuska et al. [I. Babuska, B. Q. Guo, “The h, p and h-p version of the finite element method: basis theory and applications,” Advances in Engineering Software, Volume 15, Issue 3-4, 1992]. Babuska discovered that the finite element method converges exponentially fast when the computational scheme is refined using a suitable combination of h-refinements (e.g., dividing elements into smaller ones) and P-refinements (e.g., increasing their polynomial degree). The logic is very different from a standard FEM computation, as rather than assembling and computing a single solution at a given frequency, a sequence of solutions of increasing h or P complexity is assembled and solved. After each computation, an a posteriori error estimator analyses the result and defines new order and mesh refinements until the solution is judged satisfactory [J. R. Stewart, T. J. R. Hughes, “An a posteriori error estimator and hp-adaptive strategy for finite element discretizations of the Helmholtz equation in exterior domains,” Finite Elements in Analysis and Design, Volume 25, Issues 1-2, 1997].

In most cases, the hP-FEM approach is based on hierarchical functional spaces. In these spaces, higher-order basis B(P+1) are obtained from the basis B(P) by adding new shape functions only. This is provided for P-adaptivity finite element codes since shape functions do not have to be changed completely when increasing the order of interpolation of a given element. FIG. 4 discloses an example of hierarchical basis on a quadrangle for the order=3. The first row includes the shape functions for the order P=1, which are not modified.

The hP-adaptive approach is computationally very efficient, as the hP-adaptive approach allows the computational effort, for a given problem, to be truly optimized. However, the downside is that automatic mesh refinements are to be provided. In terms of programming, hP-FEM is very challenging. It is much harder to implement and to maintain a hP-FEM solver than a standard FEM solver.

Therefore, some prior art approaches propose to simply use high-order finite element approaches, without resorting to any adaptive refinement scheme (e.g., no a priori or a posteriori estimator is discussed) and not in the context of a multi-frequency computation. This may be referred to as P-FEM methods, like in the following references: S. Petersen, D. Dreyer and O. von Estorff, “Assessment of finite and spectral element shape functions for efficient iterative simulations of interior acoustics,” Computers Methods in Applied Mechanics and Engineering, 195, 6463-6478, 2006, and P. E. J. Vos, S. J. Sherwin and R. M. Kirby, “From h to p Efficiently: Implementing finite and spectral/hp element discretisations to achieve optimal performance at low and high order approximations,” Journal of Computational Physics, 229, 2010.

Another approach is the following one. As already explained, in most acoustic applications, the solution of the stationary wave propagation problems is to be provided at more than one frequency. Very often, the solution of the stationary wave propagation problems is to be provided over a wide frequency range (e.g., the audio frequency range) and for a large number of frequencies. This type of problem is referred to as a frequency sweep problem. Methods to accelerate this multi-frequency problem are called Fast Frequency Sweep (FFS) methods. The FFS methods try to accelerate the standard low order FEM rather than resorting to higher order solutions. The FFS methods solve the solution at a few particular frequencies and extrapolate the solution approximately in the neighborhood based on the knowledge of the solution and of high order derivatives like in the following reference: M. S. Lenzi, S. Lefteriu, H. Beriot, W. Desmet, “A fast frequency sweep approach using Padé approximations for solving Helmholtz finite element models,” Journal of Sound and Vibration, Volume 332, Issue 8, 2013.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a simulation of sound emission and propagation of a system over a wide frequency range is optimized by choosing a more efficient method in terms of accuracy, time of calculation and occupied memory.

In tone embodiment, a method for predicting emission by a source of sound and a propagation of the sound within a surrounding medium, over a wide frequency range, is provided.

One or more of the present embodiments lie at the intersection of both hP-adaptative methods and Fast Frequency Sweep Methods. An approach to more efficiently compute the frequency sweep problem, but without any approximation, is provided. An algorithm for solving a wave propagation problem at multiple frequencies using a domain method based on hierarchical high-order discretization and on the use of an a priori estimator is provided.

Thanks to the use of high-order shape functions, the effort may be adapted to the need at each frequency (e.g., low effort at low frequency and large effort at high frequency).

Thanks to the use of an a priori estimator, only one solution is computed per frequency and not a sequence of solutions like in prior art hP-adaptive FEM.

Thanks to the hierarchy of the shape function basis, the mass and stiffness elementary matrices K_{e,i} and M_{e,i}, relative to all elements, may be pre-computed before the frequency loop, in spite of the fact that the interpolation order varies from one frequency to the other.

All these aspects allow the time of calculation necessary for multi-frequency simulations to be reduced considerably.

In another embodiment, a software program product including a non-transitory computer-readable storage medium that stores instructions executable by one or more processors for predicting emission by a source of sound and a propagation of the sound within a surrounding medium, over a frequency range, is provided. A system including the source and the surrounding medium is represented by elements.

### BRIEF DESCRIPTION OF THE DRAWINGS

FIG. 1 illustrates an example of sound emission inside a car cavity, with grey scale indicating the level of audible sound pressure inside the cavity at a given frequency;

FIG. 2 illustrates a coarse mesh of a car, used for a low frequency f₁;

FIG. 3 illustrates a refined mesh of the car of FIG. 2, used for a high frequency f_{N}_{_{f}};

FIG. 4 illustrates an exemplary hierarchical basis for a given order P;

FIG. 5 illustrates an intermediate solution of a typical hP-adaptive FEM on a given 2D simulation problem;

FIG. 6 illustrates the final solution of the typical hP-adaptive FEM of the problem of FIG. 5;

FIG. 7 illustrates an exemplary repartition of the element orders as given by the a priori estimator on a simple 2D mesh at frequency f₁, where elements e₁ and e₂ are presented;

FIG. 8 illustrates a similar exemplary repartition of the element orders as given by the a priori estimator on a simple 2D mesh at frequency f_{N}_{_{f}}, where elements e₁ and e₂ are presented;

FIG. 9, FIG. 10 and FIG. 11 illustrate the flowcharts of an embodiment of a method, FIG. 9 illustrating computation of a maximum element order P_{e,max}, FIG. 10 illustrating computation of all the elementary matrices based on P_{e,max}, and FIG. 11 illustrating a final phase of multi-frequency computation; and

FIG. 12 illustrates exemplary hierarchically embedded elementary matrices.

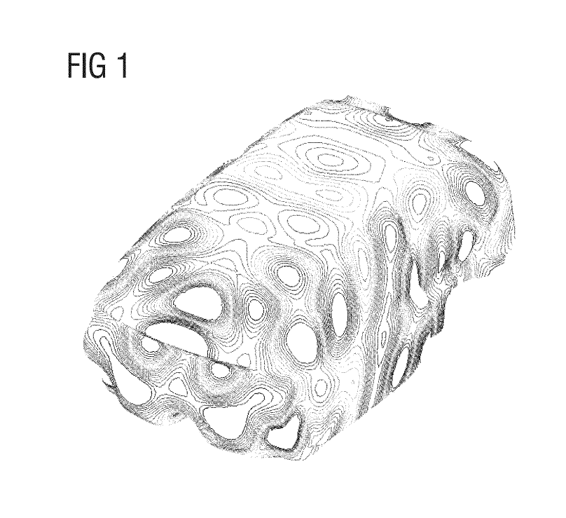

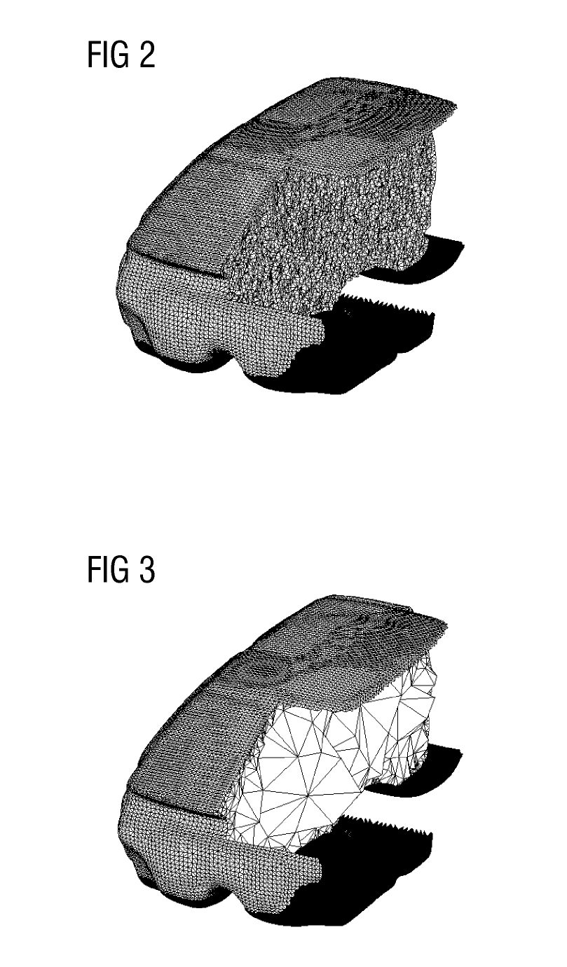

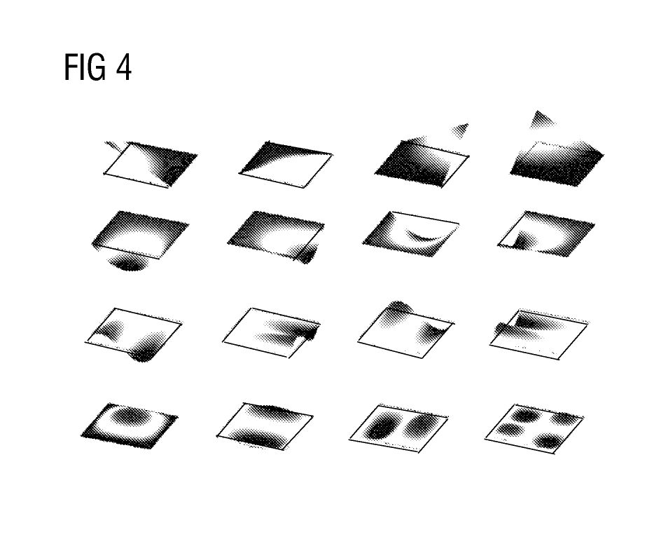

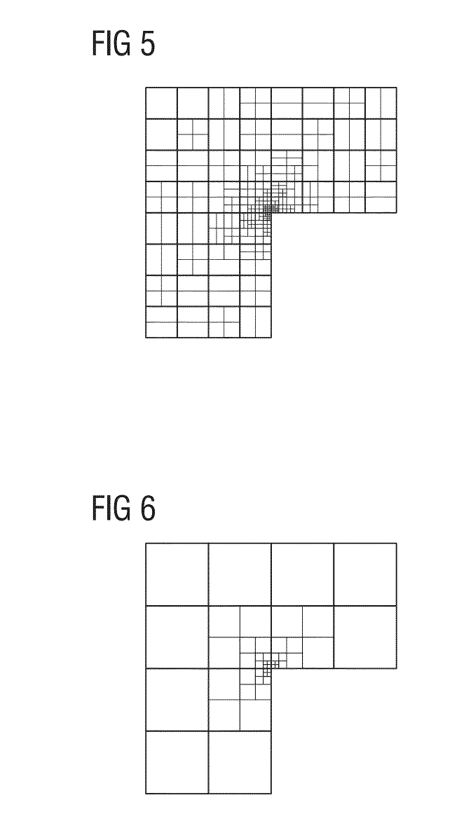

### DETAILED DESCRIPTION

One or more of the present embodiments includes an efficient implementation of a hierarchic high-order domain method (FEM or DGM) to more efficiently resolve frequency sweep problems through an efficient multi-frequency strategy based on a dedicated a priori error estimator. No P-adaptive or h-adaptive schemes are considered in the context one or more of the present embodiment, the mesh is fixed, and only one computation is performed per frequency.

Using the hierarchic properties of the finite element space, the weak formulation is computed only once (e.g., at the largest frequency of interest). The sub-matrices are extracted and assembled at lower frequencies based on the a-priori error estimator.

This method lies in the conjunction of three concepts, the use of an a priori error estimator, the use of hierarchy to construct the mass and stiffness matrix, and the multi-frequency computation.

In hP-FEM methods, a priori error estimators may be used to help designing the initial mesh in the hP-refinement process. The a priori error estimator denotes the pre-processing technique that will, prior to the equation solving, assign a given interpolation order to each element inside the finite element mesh. The a priori error estimator is a function that outputs the order P_{e,i} required on a given 1D, 2D or 3D element e (e.g., line, triangle, quadrangle, tetrahedron, hexahedron, prism) at a given frequency fᵢ based on the characteristic element length hₑ (e.g., the maximum edge length), the frequency value fᵢ, the characteristic local medium properties (e.g., speed of sound c₀_{ₑ}, mean flow magnitude if any).

In first approximation, the following equation may be applied to approach P_{e,i}:

$${P}_{e , i} = 6 \frac{ {h}_{e} {f}_{i}}{{c}_{0 e}}$$

This equation provides that the density of degrees of freedom per element is equal to 6.

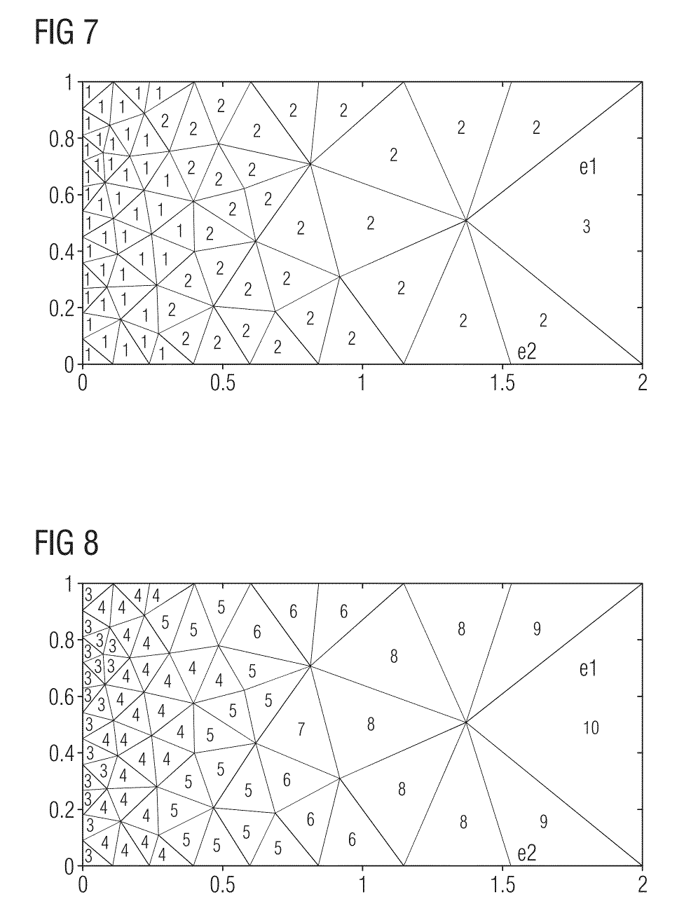

By way of examples, FIG. 7 and FIG. 8 illustrate how this formula may be adopted in practice to define the element order in an example structure (e.g., a rectangular mesh). FIG. 7 and FIG. 8 represent an example of repartition of element order P_{e,i} in a mesh at a frequency f₁ and f₂, respectively, with f₂ being higher than f₁. Element orders P_{e,i} have been determined by using an a priori estimator. FIGS. 7 and 8 indicate that the order is directly proportional to the element size and to the frequency value. If the speed of sound c₀_{ₑ} is not frequency dependent (which is the case most of the time), the largest order may be found at the highest frequency of interest f_{N}_{_{f}}.

For clarity purposes, two elements have been numbered e₁ and e₂ in FIG. 7 and FIG. 8.

For the two elements e₁ and e₂:
P_{1,1}=3 (e₁ at frequency f₁)
P_{2,1}=2 (e₂ at frequency f₁)
P_{1,2}=10 (e₁ at frequency f₂)
P_{2,2}=9 (e₂ at frequency f₂)

With low-order methods, the system assembly (e.g., the evaluation of the elementary matrices) is inexpensive in comparison with the system solving (e.g., the factorization of the global system matrix). With high-order methods, the effort balance between these two major operations is modified, and the evaluation of the elementary matrices may become as computationally intensive as the system solving due to the presence of high-order integrals in the elementary equations.

The hierarchy is not used to increase the order a posteriori on a given element to improve the solution at one frequency (e.g., like done in the hp-adaptive methods) but to increase a priori the order of the full mesh from one frequency to the other in view of accelerating the computation of multiple frequencies.

Multi-frequency computation refers to the fact that the computation is done over a wide frequency range.

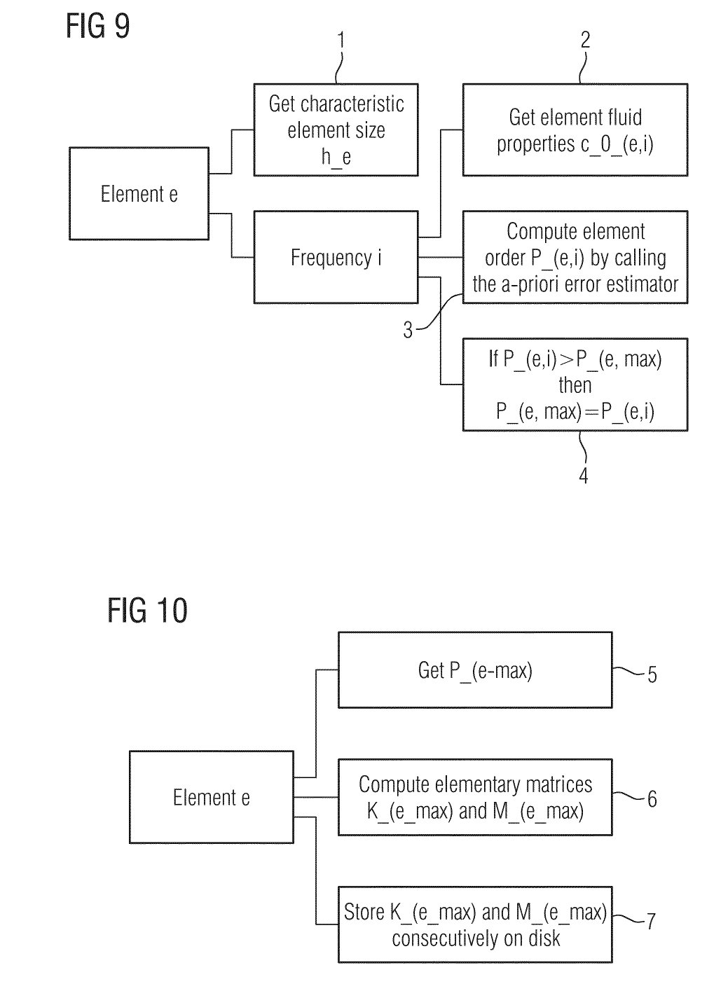

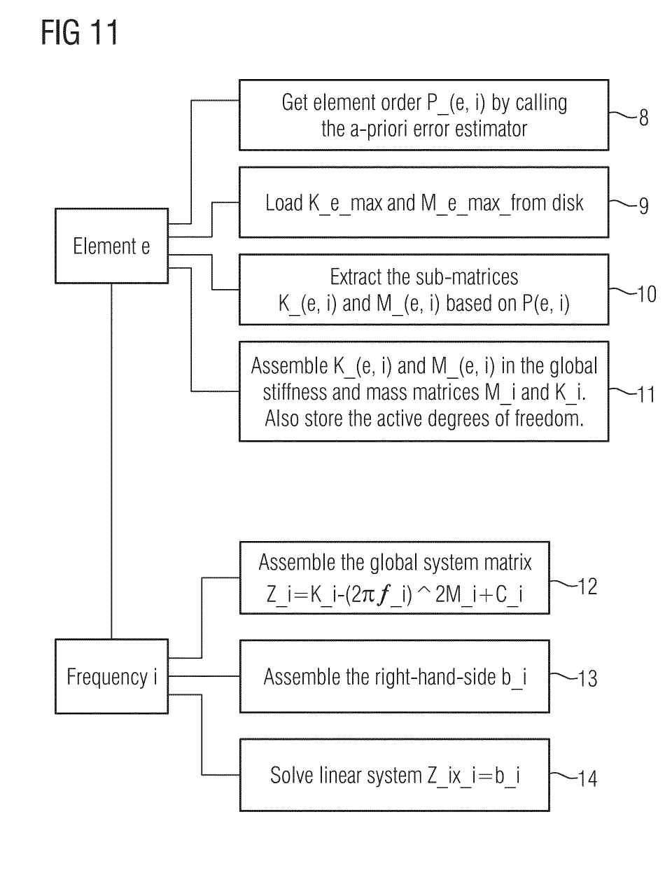

An embodiment of a method for predicting emission by a source of sound and propagation of the sound within a surrounding medium, over a wide frequency range, is illustrated in FIG. 9, FIG. 10 and FIG. 11.

The list of inputs provided by the user is the following: a mesh of Nₑ elements suitable for Finite Element or Discontinuous Galerkin Methods representing the problem, a set of boundary conditions, sources and/or material properties defining the problem, and a list of N_{f} frequencies F=[f₁, f₂, . . . , f_{N}_{_{f}}] in ascending order.

The process begins with a pre-processing part that may be divided into two phases, the maximum element order assessment, and the maximum elementary matrix computation.

The first phase of the pre-processing part is the maximum element order assessment. During this phase, an element order P_{e,i} is associated to each element e and at each frequency fᵢ by calling an a priori estimator for each element in the mesh. Then, a maximum element order P_{e,max} is determined for each element, over the frequency range.

In mathematical form, this may be written as:

$${P}_{e , ma x} = {max}_{i} {P}_{e , i}$$

Coming back to our previous example relative to FIG. 7 and FIG. 8, this phase of maximum element order assessment would result in:
P_{1,max}=10 and
P_{2,max}=9.

The complete process of this first phase is presented in FIG. 9.

In act 1 of the process, the mesh, given as an input, is read and characteristic element dimension hₑ is obtained for each element.

For each element e and for each frequency fᵢ, in act 2, local fluid properties are introduced, and in act 3 and act 4, an a priori estimator is called to determine the maximum element order P_{e,max} associated to each element. In case the fluid properties are not frequency dependent, the maximum order will be determined from the value at the maximum frequency of analysis f_{N}_{_{f}}. In case of frequency dependent fluid materials, other scenarios may occur.

At the end of this first phase of the pre-processing part, a maximum element order P_{e,max} is stored for each element, in an array of size Nₑ.

The second phase of the pre-processing part is the maximum elementary matrix computation.

The complete process of this second phase is presented in FIG. 10.

For each element e, in act 5, the maximum order element P_{e,max} is loaded, and then, in act 6, the frequency independent elementary mass and stiffness matrices M_{e,max} and K_{e,max}, respectively, are formed by using the maximum element order P_{e,max}. Consecutively, in act 7, the elementary matrices M_{e,max} and K_{e,max} are stored on disks in binary format.

Thanks to the a priori estimator, elementary matrices K_{e,max} and M_{e,max} are computed only once for each element, for an order corresponding to the maximum order element. There is no frequency loop in this phase.

After completion of these two pre-processing phases, the multi-frequency computation part may begin with a loop over the frequencies required by the user. The complete process of this second part is presented in FIG. 11.

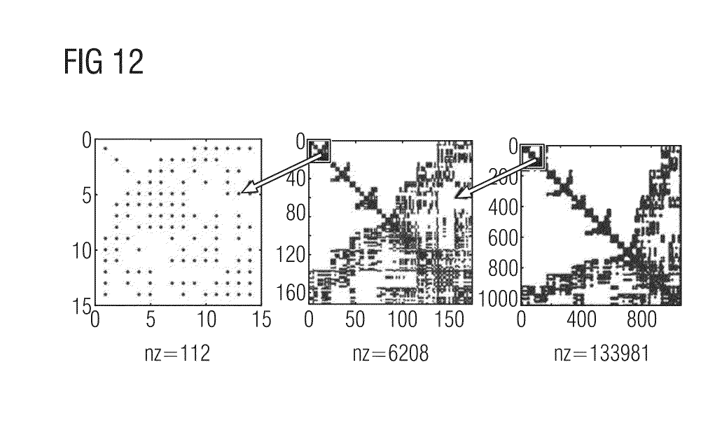

For each frequency fᵢ, for each element e: in act 8, the order of the element P_{e,i} required for this frequency and this element is computed; in act 9, the maximum elementary matrices K_{e,max} and M_{e,max} corresponding to P_{e,max} are retrieved; and in act 10, the elementary matrices K_{e,i} and M_{e,i} corresponding to the interpolation order P_{e,i} are extracted out of K_{e,max} and M_{e,max}. The use of hierarchy is important for this act. In prior art, K_{e,i} and M_{e,i} matrices were computed from scratch at each frequency, whereas in one or more of the present embodiments, due to the hierarchic structure of the basis, the matrices corresponding to P_{e,i} are contained as a subset of the matrices for P_{e,max}. This is illustrated in FIG. 12, where the matrices of lower orders are contained in the matrices of higher orders.

For each frequency fᵢ, for each element e, in act 11, the elementary matrices K_{e,i} and M_{e,i} are assembled into global matrices Kᵢ and Mᵢ, representing, respectively, the stiffness and the mass of the system at frequency fᵢ. In act 11, the list of active degrees of freedom (e.g., the subset of unknowns used for this particular frequency) is also stored.

After the achievement of the loop over the elements, for each frequency fᵢ, in act 12, the matrix corresponding to the frequency fᵢ is assembled

Zᵢ(fᵢ)=Kᵢ−(2πfᵢ)²Mᵢ+Cᵢ(f).

If frequency dependent features are needed (e.g., like boundary conditions), the corresponding contribution is added in Cᵢ(fᵢ). Zᵢ will be very small at low frequencies (e.g., where the P_{e,i} are small) and larger as the frequency approaches the maximum frequency. The computational effort is therefore implicitly adapted for each frequency.

In act 13, the right-hand-side representing the sources is assembled

In act 14, the system is solved using a linear solver.

One or more acts of the method of one or more of the present embodiments may be executed by one or more processors.

The advantage of the method described above is based on the fact that the effort is adapted at each frequency based on the a priori error estimator and on the fact that the elementary matrices are evaluated only once, before the frequency loop, which reduces the time of calculation for multi-frequency simulations considerably.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for predicting emission by a source of sound and a propagation of the sound within a surrounding medium, over a frequency range, wherein a system, including the source and the surrounding medium, is represented by elements, the method comprising:
for each of the elements and each frequency fᵢ:
associating a parameter P_{e,i} to the element by an a priori error estimator, characterizing a polynomial degree used to approximate a sound field, at frequency fᵢ; and
determining, by a processor, a parameter P_{e,max} for the element, corresponding to a maximum P_{e,i} parameter calculated by the priori error estimator over the frequency range;
for each of the elements:
determining elementary matrices K_{e,max} and M_{e,max} characterizing a contribution by the element to a stiffness and the mass, respectively, of the system using the parameter P_{e,max}; and
for each frequency fᵢ:
for each of the elements:
determining the polynomial degree used to approximate the sound field, the determining comprising using the parameter P_{e,i}; and
extracting out elementary matrices K_{e,i} and M_{e,i}, relative to all of the elements, of the matrices K_{e,max} and M_{e,max} and assembling the extracted out elementary matrices K_{e,i} and M_{e,i} into global matrices Kᵢ and Mᵢ representing, respectively, the stiffness and the mass of the system;
establishing a global matrix system based on the global matrices Kᵢ and Mᵢ; and
solving the global matrix system using a linear solver.

2. The method of claim 1, further comprising providing a mesh that represents the system as an input at the beginning of the method.

3. The method of claim 1, further comprising providing a list of discrete frequencies at which the frequency range is to be sampled as an input at the beginning of the method.

4. The method of claim 1, further comprising providing a set of boundary conditions, sources and material properties of the system as an input at the beginning of the method.

5. The method of claim 1, wherein local fluid properties are introduced for each of the elements.

6. The method of claim 1, wherein the global matrix system has the following form:
Zᵢ(fᵢ)=Kᵢ−(2πfᵢ)²Mᵢ+Cᵢ(f)
with Kᵢ and Mᵢ representing, respectively, the stiffness and the mass of the system, Cᵢ(fᵢ) representing all other frequency dependent terms arising from the boundary conditions, and fᵢ being the frequency of concern.

7. In a non-transitory computer-readable storage medium that stores instructions executable by one or more processors for predicting emission by a source of sound and a propagation of the sound within a surrounding medium, over a frequency range, wherein a system, including the source and the surrounding medium, is represented by elements, the instructions comprising:
for each of the elements and each frequency fᵢ:
associating a parameter P_{e,i} to the element by an a priori error estimator, characterizing a polynomial degree used to approximate a sound field, at frequency fᵢ; and
determining a parameter P_{e,max} for the element, corresponding to a maximum P_{e,i} parameter calculated by the priori error estimator over the frequency range;
for each of the elements:
determining elementary matrices K_{e,max} and M_{e,max} characterizing a contribution by the element to a stiffness and the mass, respectively, of the system using the parameter P_{e,max}; and
for each frequency fᵢ:
for each of the elements:
determining the polynomial degree used to approximate the sound field, the determining comprising using the parameter P_{e,i}; and
extracting out elementary matrices K_{e,i} and M_{e,i}, relative to all of the elements, of the matrices K_{e,max} and M_{e,max} and assembling the extracted out elementary matrices K_{e,i} and M_{e,i} into global matrices Kᵢ and Mᵢ representing, respectively, the stiffness and the mass of the system;
establishing a global matrix system based on the global matrices Kᵢ and Mᵢ; and
solving the global matrix system using a linear solver.

8. The non-transitory computer-readable storage medium of claim 7, wherein the instructions further comprise providing a mesh that represents the system as an input at the beginning of the method.

9. The non-transitory computer-readable storage medium of claim 7, wherein the instructions further comprise providing a list of discrete frequencies at which the frequency range is to be sampled as an input at the beginning of the method.

10. The non-transitory computer-readable storage medium of claim 7, wherein the instructions further comprise providing a set of boundary conditions, sources and material properties of the system as an input at the beginning of the method.

11. The non-transitory computer-readable storage medium of claim 7, wherein local fluid properties are introduced for each of the elements.

12. The non-transitory computer-readable storage medium of claim 7, wherein the global matrix system has the following form:
Zᵢ(fᵢ)=Kᵢ−(2πfᵢ)²Mᵢ+Cᵢ(fᵢ)
with Kᵢ and Mᵢ representing, respectively, the stiffness and the mass of the system, Cᵢ(fᵢ) representing all other frequency dependent terms arising from the boundary conditions, and fᵢ being the frequency of concern.
